(19) United States
(12) Patent Application Publication
(10) Pub. No.: US 2025/0222473 A1
(43) Pub. Date: Jul. 10, 2025

(54) A PROCESS AND SPRAYING DEVICE FOR ARC SPRAYING CARBON STEEL PIPES

(71) Applicant: Jian YANG, Zibo (CN)

(72) Inventor: Jian YANG, Zibo (CN)

(21) Appl. No.: 18/290,939

(22) PCT Filed: Nov. 9, 2023
(86) PCT No.: PCT/CN2023/130660

§ 371 Date: Jan. 22, 2024

(30) Foreign Application Priority Data
Nov. 3, 2023 (CN) 202311455075.4

(51) Int. Cl. B05B 5/12; B05B 5/06; B05B 5/14; C23C 4/131; C23C 4/16

(52) U.S. Cl. CPC B05B 5/12; B05B 5/06; B05B 5/14; C23C 4/131; C23C 4/16

(57) ABSTRACT

The present invention relates to the field of surface alloy pipe manufacturing, and provides a process and spraying equipment for arc spraying carbon steel pipes. The process includes the following steps: S1: installing a raw metal wire on a wire feeder, adjusting the wire feeding voltage according to the required thickness of spraying, and adjusting the spraying current according to the material of the raw metal wire; S2: spraying an inner and outer walls of the pipe through an inner wall spray gun and an outer wall spray gun; S3: after the pipe being sprayed, cooling it naturally to room temperature; S4: putting the cooled pipe into a heating furnace, adjusting the heating temperature according to the required surface alloy thickness, and cooling it in the furnace or natural cooling outside the furnace after the insulation is completed; meanwhile, a surface alloy layer is formed on the inner and/or outer wall of the carbon steel pipe; S5: after the pipe being cooled to room temperature, using a medium frequency heat treatment equipment to heat-treat the pipe through the heat treatment process. The present invention solves the problems that the existing arc spray equipment cannot spray the inner wall of the pipe, and the spray coating has poor bonding force with the pipe body and is easy to fall off. It greatly improves the wear resistance, high temperature resistance and anti-corrosion performance of the inner and outer wall surfaces of the pipe, and increases the pipe life.

### TECHNICAL FIELD

The present invention relates to the field of surface alloy pipe manufacturing, in particular, which relates to a process and spraying device for arc spraying carbon steel pipes.

### BACKGROUND OF THE INVENTION

Pipe corrosion phenomenon is widespread in the oil and gas fields in all countries of the world, and the direct or indirect economic losses caused by pipe corrosion every year are very huge, how to effectively prevent pipe corrosion has become an urgent problem for major pipe manufacturers around the world. Currently, there are three main types of anti-corrosion technologies used worldwide:
1. The use of plating, coating anti-corrosion material layer or sintered glass lining. Its adhesion strength with the pipe substrate is poor, wear resistance is also poor, with the irregular wear, oil and air erosion, etc., it is easy to cause local failure of the anti-corrosion layer or the whole flaking, resulting in anti-corrosive failure, serious production accidents.
2. The use of corrosion inhibitors to slow down the corrosion rate of the pipe. This method is only applicable to oil and gas wells where the corrosion is light and the well temperature does not exceed 200° C., and it does not have the property of increasing the wear-resistant performance by itself, and the corrosion of the worn parts will be very serious in the irregular-wear wells.
3. The use of alloy pipes such as nickel-based alloy. As the price of nickel-based alloy and other alloy pipes is very expensive, the cost of one well will be tens of millions of yuan, only individual high-yield wells are suitable for the use of this type of alloy pipe, and the vast majority of non-high-yield wells can not afford the price of this type of pipe.

With the development of oil and gas field mining technology, the demand for pipes increases, but also puts forward to the pipe corrosion resistance, wear resistance, high-temperature resistance and price-appropriate use requirements, but the products in the existing technology can often only achieve one or two of these requirements. How to fully meet the requirements of modern oil and gas field mining technology on the pipe has become a technical problem that can not be solved by today's pipe manufacturers.

### SUMMARY OF THE INVENTION

The present invention provides a process and spraying device for arc spraying carbon steel pipes, to solve the problem of corrosion resistance, wear resistance, high-temperature resistance and price-appropriate use requirements that cannot be met by the existing manufacturing process of carbon steel pipes, so that the pipe can be used for a long period of time in high-temperature service and has a high degree of corrosion and wear resistance, and its technical solutions are described below:

A process for arc spraying carbon steel pipes, including the following steps:
S1: Install the raw metal wire to the wire feeder, adjust the wire feeding voltage according to the spraying thickness, and adjust the spraying current according to the material of the raw metal wire;
S2: Spray the inner wall and outer wall of the pipe by means of an inner wall spray gun and an outer wall spray gun;
S3: After the pipe is sprayed, naturally cool it to room temperature;
S4: Put the cooled pipe into the heating furnace, adjust the heating temperature according to the required surface alloy thickness. After the end of the insulation for the furnace cooling or natural cooling outside the furnace. At this time, a surface alloy layer is formed on the inner and/or outer wall of the carbon steel pipe.
S5: After the pipes are cooled down to room temperature, the pipes are heat-treated using intermediate-frequency heat-treatment equipment according to the heat-treatment process.

Before step S1, the inner and outer walls of the carbon steel pipe need to be shot blasted and descaled, respectively, so that the inner and outer walls of the pipe show the basic color of metal.

In step S2, the spraying of the inner wall and the outer wall of the pipe by the inner wall spray gun and the outer wall spray gun includes two ways, the first is to keep the inner wall spray gun immobile, the pipe is fixed to a rotary chuck, and the said rotary chuck drives the pipe to move by moving the slide, so as to make the inner wall spray gun and the outer wall spray gun spraying at the same time; the second is to keep the pipe immobile, the pipe is fixed to a rotary chuck, and feed the wire feeder and the inner wall spray gun to the inner wall of the pipe, stop them after they have travelled to the other end of the pipe, and then the wire feeder and the inner wall spray gun move backward to carry out the inner wall spraying simultaneously.

The said carbon steel pipe is sprayed with the inner wall spray gun and/or outer wall spray gun moving at a speed of 0-0.3 m/s relative to the pipe.

In step S4, the said surface alloy layer is an aluminium-iron alloy, a copper-iron alloy or a copper-aluminium-iron alloy-based alloy layer, which accounts for more than 80% of the entire surface alloy layer; the said surface alloy layer has a thickness of 30-600 μm, and a hardness of 300-600 HV_{0.1}.

In step S4, the said heating furnace is resistance heating furnace, direct current heating furnace or intermediate-frequency furnace; the heating temperature is in the range of 800-1200° C. and the holding time is 10-300 minutes. A spraying device for arc spraying carbon steel pipe includes control cabinet, wire feeder, raw metal wire, inner wall spray gun, outer wall spray gun, rotary chuck and moving slide, the said control cabinet is used for all the manipulation of the spraying device, the lower end of the said rotary chuck is mounted on a moving slide for fixing the pipes and rotating the pipes, the said inner wall spray gun and outer wall spray gun are used for spraying the inner and outer walls of the pipes, the said raw metal wires are sent to the end of the inner wall spray gun through the wire feeder, the raw metal wires at the end form the molten metal in the case of electric power, which is blown by the air to the surface of the inner wall of the pipes.

The end of said inner wall gun includes a gun housing, a main air circuit, an auxiliary air circuit, an air cap, a copper row, a conductive nozzle, a conductive tube and a conductive rod. For the open part of said gun housing, the upper edge exceeds the lower edge, the internal space is provided from top to bottom with a main air circuit and an air cap, the air outlet of said main air circuit exceeds the air cap and blows downwards; The said air cap is connected to an auxiliary air circuit and a conductive nozzle, and the said conductive nozzle is connected to a copper row, a conductive rod, and a conductive tube in turn; the said copper row is used to conduct electricity from a power source to the conductive nozzle.

The said air cap includes an air blowing port, a positive electrode, a negative electrode and an air gathering port, the said air blowing port is located above the air gathering port, the left and right sides of said air gathering port are respectively a positive electrode and a negative electrode, the said positive electrode is a raw metal wire connected to the positive pole of power supply, and the negative electrode is a raw metal wire connected to the negative pole of power source, and the said positive electrode and negative electrode are connected to a conductive nozzle.

The air source of said air blowing port is provided by an auxiliary air circuit, and the air gathering port converges the air blown out from the air blowing port and blows out from the air gathering port, the said main and auxiliary air circuits are distributed in different directions and positions, and the main air circuit blows the melted metal out of the air gathering port to the inner wall of the pipe, forming a spray angle of 60°-90° with the pipe wall to ensure the adhesion and homogeneity of the spraying.

The connecting pipe of said inner wall spray gun includes a gas duct, a metal wire duct and a positive and negative cable, the said gas duct is located in the middle of the connecting pipe, and the left and right sides outwardly are sequentially provided with a positive and negative cable and a metal wire duct, the said wire feeder pushes the raw metal wires into the metal wire duct, which is pushed all the way through the metal wire duct to the end position of the inner wall spray gun, the said gas duct is connected to the main gas circuit and the auxiliary gas circuit, the said metal wire duct is connected to the conductive tube, and the said positive and negative cables are connected to the conductive nozzles through copper rows, so that the two raw metal wires are formed into a positive electrode and a negative electrode, respectively.

The said inner wall spray gun has an outer diameter of 40-150 mm and a length of 2.5-15 m.

The said rotary chuck includes motor, chuck, rotating roller, driving transmission shaft, bearing and cylinder. The chuck is fixed on the transmission shaft, which is fixed by two bearings and driven by the motor, so as to make the chuck rotate. The rotating rollers are two rollers fixed on the steel plate, the lower side is connected to the cylinder, which can be lifted by the cylinder to avoid the collision of the chuck and effectively support the pipe body.

The said raw metal wire is an aluminium wire with an aluminium element content of 99% or more or a copper wire with a copper element content of 99% or more or a copper-aluminium mixed wire with a common content of the elements aluminium and aluminium of 99% or more.

With the development of oil and gas field mining technology, the demand for pipes increases, but also puts forward to the pipe corrosion resistance, wear resistance, high-temperature resistance and price-appropriate use requirements, surface alloy pipes have solved all the above problems. Further, the present invention has the following beneficial effects:
(1) The inner wall (and/or) outer wall of the carbon steel pipe has formed a uniform surface alloy layer with a thickness of 30-600 μm, which is mainly made of aluminium-iron alloy, and its hardness can reach 400-600HV_{0.1}, which is much higher than that of the ordinary carbon steel pipe, and greatly improves the abrasion resistance of the pipe. The corrosion resistance of surface alloy layer to H2S, CO2, Cl— and other corrosion resistance is several times that of ordinary carbon steel pipes, and because of the dense oxide film on the surface of the alloy layer, the surface alloy pipe will not appear hydrogen-induced stress corrosion cracking phenomenon.
(2) The surface alloy layer is metallurgically bonded to the carbon steel pipe substrate, which has a better bonding strength than other processes such as plating, coating of anti-corrosion material layer or sintered glass lining, etc., and coupled with the improved surface hardness of the alloy layer, the surface alloy layer will not fall off even if there is a serious irregular-wear phenomenon.
(3) The surface alloy layer also has excellent high-temperature resistance, and will not change under 800° C., making it ideal for use in high-temperature working environments, and its corrosion resistance is even better at high temperatures than at low temperatures.
(4) The invention can be applied to pipes with internal diameters as small as 50 mm, which is difficult to do with other arc spraying equipment.

### BRIEF DESCRIPTION OF THE FIGURES

FIG. 1 is a structure diagram of the spraying equipment for said arc spraying carbon steel pipes;

FIG. 2 is a sectional view of said carbon steel pipe after spraying FIG. 3 is a sectional view of said inner wall spray gun;

FIG. 4 is a vertical view of said inner wall spray gun;

FIG. 5 is a structure diagram of the muzzle air cap of said inner wall spray gun;

FIG. 6 is a sectional view of the connecting pipe of said inner wall spray gun;

FIG. 7 is a structure diagram of said rotary chuck;

FIG. 8 is a schematic diagram of a second way of spraying the inner bore of said carbon steel pipe;

FIG. 9 is a flow diagram of said process for arc spraying carbon steel pipes.

### DETAILED DESCRIPTION OF THE INVENTION

The technical solutions of the present invention will be further described in conjunction with the attached Figures and the Examples, but is not intended to be a limitation of the present invention.

A spraying device for arc spraying carbon steel pipes as shown in FIG. 1 includes control cabinet 11, wire feeder 12, raw metal wire 13, inner wall spray gun 14, roller 15, outer wall spray gun 16, rotary chuck 17 and moving slide 18, and all the manipulations of the said spraying device are done by the control cabinet 11. The said control cabinet 11 includes power supply and control system which is connected to the wire feeder 12, inner wall spray gun 14, outer wall spray gun 16, rotary chuck 17 and moving slide 18 for setting relevant parameters. The said inner wall spray gun 14 and outer wall spray gun 16 are used for spraying the inner and outer walls of the pipes, the said raw metal wire 13 is sent to the end of the inner wall spray gun 14 through the wire feeder 12, the raw metal wire 13 at the end forms the molten metal in the case of electric power, which is blown by the air to the surface of the inner wall of the pipes. The said roller 15 mainly serve to support the inner wall gun 14 and can be lifted up and down to ensure that they do not obstruct the pipe to be sprayed.

The said rotary chuck 17 is used to fix the pipe and to drive the pipe to rotate, the lower end of said rotary chuck 17 is mounted on a moving slide 18, through which the pipe is driven to move, the said slide 18 serves to provide a track for the pipe to move back and forth. The said moving slide 18 sends the rotary chuck 17 to a predetermined position, so that the end of inner wall spray gun 14 and the muzzle of outer wall spray gun 16 are flush with the end of pipe, and spraying starts. When spraying, inner wall spray gun 14 and outer wall spray gun 16 spray at the same time, while rotary chuck 17 drives the pipe to rotate, the moving slide 18 drives the rotary chuck 17 to move uniformly away from the spray gun. When the pipe is fully sprayed, the spraying is turned off.

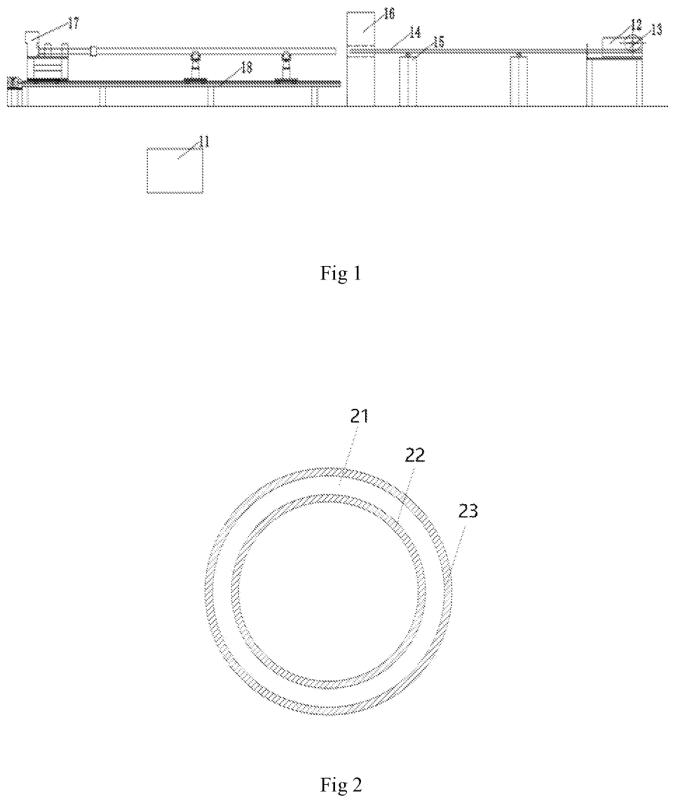

As shown in FIG. 2, after spraying by the inner wall spray gun 14 and outer wall spray gun 16, the said carbon steel pipe forms a surface aluminium-iron alloy pipe after spraying, which includes pipe body 21, surface alloy layer 22 on the pipe inner wall and surface alloy layer 23 on the pipe outer wall, with a spraying thickness of 30-600 μm and a hardness of 300-600 HV_{0.1}.

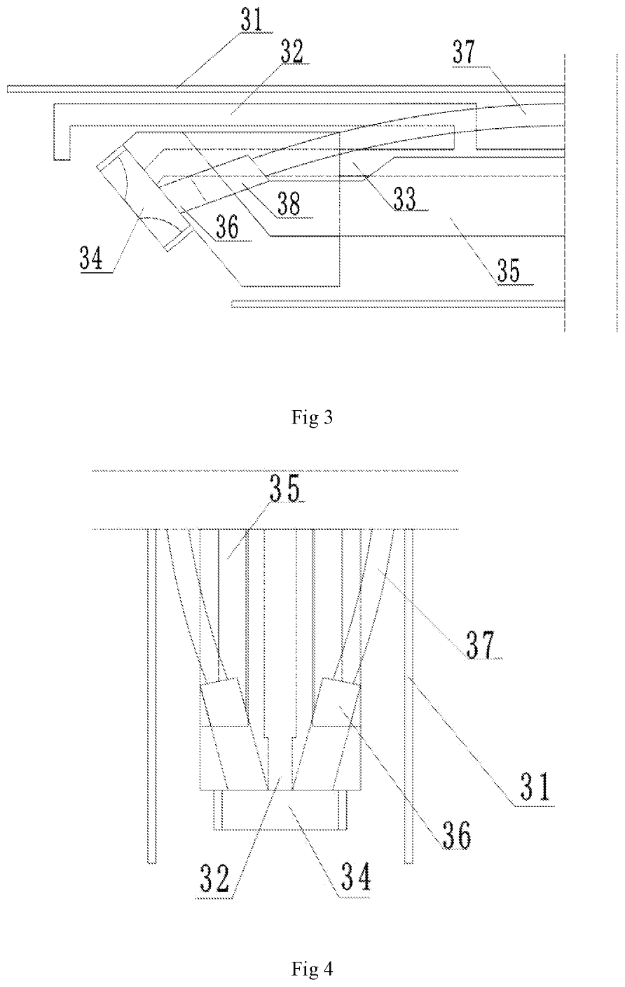

As shown in FIGS. 3 and 4, the said inner wall gun 14 completes the spraying of pipe inner wall during the spraying process, comprising a gun head and a gun body, in which the said gun head is made of a cable or insulated copper row (35) welded directly to the conductive rod to ensure good electrical conductivity. The gun body is made of a connecting pipe of metal carbon steel, 1-15 meters in length, with two built-in insulated copper rows or cables, one gas duct and two wire ducts.

The said gun head, which serves as the end of the inner wall gun 14, includes a gun housing 31, a main air circuit 32, an auxiliary air circuit 33, an air cap 34, a copper row 35, a conductive nozzle 36, a conductive tube 37 and a conductive rod 38. For the open part of said gun housing 31, the upper edge exceeds the lower edge, the internal space is provided from top to bottom with a main air circuit 32 and an air cap 34, the air outlet of said main air circuit 32 exceeds the air cap 34 and blows downwards; The said air cap 34 is connected to an auxiliary air circuit 33 and a conductive nozzle 36, and the said conductive nozzle 36 is connected to a copper row 35, a conductive rod 38, and a conductive tube 37 in turn; The copper row 35 is used to conduct electricity from a power source to the conductive nozzle, the said conductive rod 38 is behind the conductive nozzle 36, and the conductive nozzle 36 and conductive rod 38 are connected by threads.

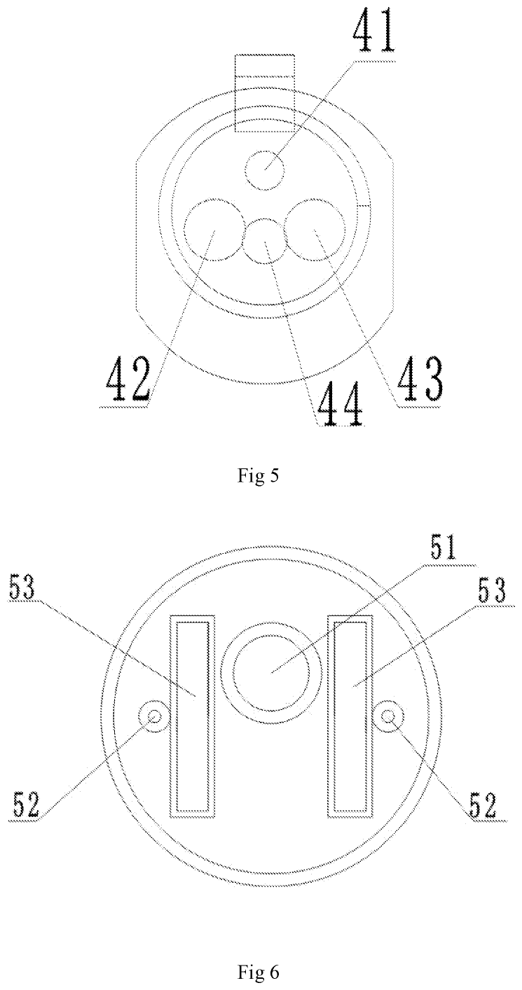

As shown in FIG. 5, the said air cap 34 is composed of an air blowing port 41, a positive electrode 42, a negative electrode 43, and an air gathering port 44, the said blowing port 41 is located above the air gathering port 44, the left and right sides of said air gathering port 44 are respectively a positive electrode 42 and a negative electrode 43. The said positive electrode 42 is a raw metal wire connected to the positive pole of power supply, and the said negative electrode 43 is a raw metal wire connected to the negative pole of power supply, when the power supply is turned on, the raw metal wires of positive electrode 42 and negative electrode 43 will melt in an instant.

The air source of said air blowing port 41 is provided by the auxiliary air circuit 33, and the air gathering port 44 converges the air blown out from the air blowing port 41 and blows out from the air gathering port 44 to increase the blowing pressure. The auxiliary air circuit 33 is a circular structure to ensure that the molten metal formed after the raw metal wire 13 is energized is ejected from the air gathering port 44. The main air circuit 32 and auxiliary air circuit 33 are distributed in different directions and positions, and the main air circuit 32 blows the molten metal out of the air gathering port 44 to the inner wall of the pipe, forming a spray angle of 60°-90° with the pipe wall to ensure the adherence and uniformity of the spraying.

As shown in FIG. 6, the connecting pipe of said inner wall gun 14 includes a gas duct 51, a metal wire duct 52 and positive and negative cables 53, the said air duct 51 is located in the middle of the connecting pipe, and the left and right sides outwardly are sequentially provided with positive and negative cables 53 and a metal wire duct 52, so that the said positive and negative cables 53 are provided with two sets and the said metal wire ducts 52 are provided with two sets. The said wire feeder 12 pushes the raw metal wire 13 into the metal wire duct 52, which is pushed all the way through the metal wire duct 52 to the end position of the inner wall spray gun 14.

The said metal wire duct 52 is connected to the conductive tube 37, which is connected to the conductive nozzle 36, and positive and negative cables 53 are connected to the conductive nozzle 36 through the copper row 35, so that the two raw metal wires 13 are formed into a positive electrode and a negative electrode, respectively. The gas duct 51 is divided into a main air circuit 32 and an auxiliary air circuit 33 at the end of the inner wall spray gun 14.

Further, the said inner wall spray gun 14 has an outer diameter of 40-150 mm and a length of 2.5-15 m.

The said outer wall spray gun 16 is a fixed device with a vertically downwardly facing muzzle, which as the device itself comes with, belongs to the prior art and will not be repeated.

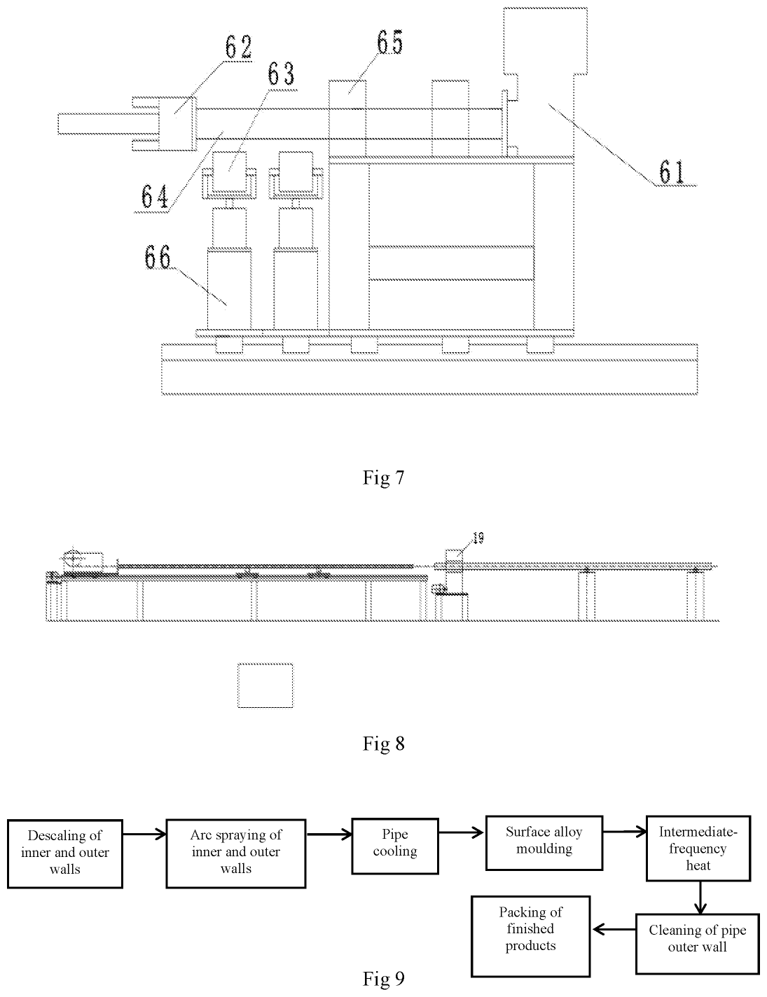

As shown in FIG. 7, the rotary chuck 17 is specially designed to ensure that the inner and outer walls of the pipe can be sprayed completely. The said rotary chuck 17 includes motor 61, chuck 62, rotating roller 63, drive transmission shaft 64, bearing 65 and cylinder 66. The chuck 62 is fixed to the transmission shaft 64, which is fixed by two bearings 65 and driven by the motor 61, so as to make the chuck 62 rotate. The rotating rollers 63 are two rollers fixed on the steel plate, the lower side is connected to the cylinder 66, which can be lifted by the cylinder 66 to avoid the collision of the chuck 62 and effectively support the pipe body.

The linkage of spraying operation is achieved by means of the rotary chuck 17: the pipe is clamped on the rotary chuck 17 and then moved to the appropriate position so that the end of the pipe is flush with the end of the inner wall spray gun 14. When spraying is switched on, the wire feeder 12 pushes a steady stream of raw metal wire 13 to the end of the inner wall spray gun 14. The wires at the end form the molten metal in the case of electric power, which is blown by the air to the surface of the inner wall of the pipes. The pipe is rotated and backed up at a uniform speed under the action of the rotary chuck 17, thereby completing the spraying of the inner wall of the pipes.

As shown in FIG. 9, in combination with the above-described spraying equipment, the said process for arc spraying carbon steel pipes includes the following steps:

S1: Install the raw metal wire to the wire feeder, adjust the wire feeding voltage (0-50V) according to the spraying thickness, and adjust the spraying current (100 A-400 A) according to the material of the raw metal wire;

S2: Spray the inner wall and outer wall of the pipe by means of an inner wall spray gun and an outer wall spray gun as follows:

Spraying the inner hole of carbon steel pipe: fix the pipe to the rotary chuck and adjust the rotary chuck speed (0-200 rpm), place the inner wall spray gun into the pipe inner hole, the inner wall spray gun travels to the other end of the pipe, turn on the equipment, the rotary chuck 17 moves backward from the front end on the moving slide 18 at a constant speed (0-0.3 m/s), the inner wall spraying of the pipe is completed. The rotary chuck 17 and moving slide 18 can be regarded as one at this time, and the aggregate of the two is referred to as the spraying trolley.

Carbon steel pipe outer wall spraying: After adjusting the rotary chuck speed, move the pipe to the position of the outer spraying port, adjust the moving speed of the rotary chuck (0-0.3 m/sec), turn on the equipment, the outer wall spraying of the pipe is completed.

S3: After the pipe is sprayed, naturally cool it to room temperature.

S4: Put the cooled pipe into the heating furnace, adjust the heating temperature within 800-1200° C. according to the required surface alloy thickness, and hold the pipe at that temperature for 10-300 minutes. After the end of the insulation for the furnace cooling or natural cooling outside the furnace. At this time, a surface alloy layer is formed on the inner (and/or) outer wall of the carbon steel pipe. The said surface alloy layer is an aluminium-iron alloy or a copper-iron alloy or a copper-aluminium-iron alloy-based alloy layer, which accounts for more than 80% of the entire alloy layer and has a hardness of 300-600HV_{0 1}.

Further, the said heating furnace is resistance heating furnace, direct current heating furnace or intermediate-frequency furnace.

S5: After the pipes are cooled down to room temperature, the pipes are heat-treated using intermediate-frequency heat-treatment equipment according to the heat-treatment process.

In the present invention, the said pipe has a diameter of 50-500 mm and a length of 3-15 m. The inner and outer walls of the carbon steel pipe need to be shot blasted and descaled respectively before it is mounted on the rotary chuck, so that the inner and outer walls of the pipe show the basic color of metal. The said raw metal wire is an aluminium wire with an aluminium element content of 99% or more or a copper wire with a copper element content of 99% or more or a copper-aluminium mixed wire with a common content of the elements aluminium and aluminium of 99% or more. The said spray thickness is 30-600 μm.

Further, in step S2, the said inner wall spraying of carbon steel pipe can be done in two ways:

The first one is to achieve simultaneous spraying of the inner wall and outer wall as shown in FIG. 1, wherein the rotary chuck 17 drives the pipe to move backward at a constant speed, and the wire feeder 12, inner wall spray gun 14 and outer wall spray gun 16 keep immobile. Specifically, the pipe is fixed to the rotary chuck 17, which is fixed on a rail trolley, the rotary chuck 17 grips the inner or outer wall of the pipe. The rotating roller 63 supporting the pipe is a universal wheel, which can ensure the rotation of the pipe and also make the pipe advance smoothly. When spraying the outer wall, the outer wall spray gun 16 is fixed on a rack with an external dust removal and anti-arc light device. The outer wall spray gun 16 is turned on when the rotary chuck 17 reaches the rotating speed, at which time the spraying trolley formed by the rotary chuck 17 and moving slide 18 moves backward, and when it moves to a certain degree, the rotating roller 63 begins to move to support the pipe and complete the spraying. The spraying method for the said outer wall is also applicable to the inner wall spraying, Fix the spraying gun 14 for the inner wall, set the carbon steel pipe into the inner wall spray gun 14 until the muzzle of the inner wall spray gun 14 reaches the other end of the carbon steel pipe, rotate the rotary chuck 17, turn on the inner wall spray gun 14, and move the spraying trolley backward to complete the spraying.

In the second way, as shown in FIG. 8, the pipe is kept immobile, the pipe is fixed by an ordinary three-jaw rotary chuck 19, the wire feeder 12 drives the inner wall spray gun 14 into the inside of the pipe, and the wire feeder 12 and inner wall spray gun 14 move backward at a constant speed when spraying. In this way, the pipe is fixed to the three-jaw rotary chuck 19, the three-jaw rotary chuck 19 is fixed relative to the ground and gripped at one end of the outer wall of the pipe, the rest of the pipe is supported by the rotary roller, and when the three-jaw rotary chuck 19 drives the pipe to rotate, the concentricity and smoothness of the pipe's rotation are ensured. The wire feeder 12 and inner wall spray gun 14 are driven by a drive motor from one end of the pipe, forward into the inner wall of the pipe, travelling to the other end of the pipe to stop, and then travelling backward to complete the spraying. The other end of the pipe is equipped with a dust removal and anti-arc light device.

The examples of the process are as follows:

### Example 1

The procedure for the production of surface aluminium-iron alloy pipe of 2-⅞ inch, steel grade J55, with a surface alloy layer thickness of 300 μm on the inner and outer walls of the pipe is as follows:

S11: Install the raw metal wire to the wire feeder and adjust the wire feeding voltage to 30V, adjust the spraying current (100-400 A) to 100 A.

S12: Spraying the inner hole of pipe: fix the pipe to the rotary chuck (hereinafter referred to as “chuck”) and adjust the chuck speed (0-200 rpm) to 100 rpm, place the inner wall spray gun into the pipe inner hole, the inner wall spray gun travels to the other end of the pipe, turn on the equipment, and the spraying trolley moves backward at a constant speed (0-0.3 m/s), the inner wall spraying of the pipe is completed. Spraying the outer hole of pipe: after adjusting the chuck speed, move the pipe to the position of the outer spraying port, adjust the moving speed of the chuck (0-0.3 m/s) to the appropriate speed, turn on the equipment, the outer wall spraying of the pipe is completed.

S13: After the pipe is sprayed, naturally cool it to room temperature.

S14: Put the cooled pipe into the heating furnace, turn on the heating, start insulation for 60 minutes when the temperature of the pipe rises to 860° C. Pull out the pipe for natural cooling outside the furnace after the end of the insulation. At this time, the surface aluminum-iron alloy layer is formed on the inner and outer wall of the carbon steel pipe.

S15: After the pipes are cooled down to room temperature, the pipes are heat-treated using intermediate-frequency heat-treatment equipment according to the heat-treatment process for steel-grade J55 pipes.

The said raw metal wire is aluminium wire with an aluminium element content of 99% or more.

After the Step S11 of the present invention, a aluminium coating of 150 μm will be formed on the inner and outer walls of the pipe, and after all the process steps have been completed, the resulting surface aluminium-iron alloy pipe includes pipe body 21, surface alloy layer 22 on the pipe inner wall and surface alloy layer 23 on the pipe outer wall. The thicknesses of surface alloy layer 22 on the pipe inner wall and surface alloy layer on the pipe outer wall can be up to 300 μm, with hardness up to 450HV_{0.1}.

### Example 2

For the production of surface copper-iron alloy layer pipe of 2-⅜-inch, steel grade N80-1, with a surface alloy layer thickness of 200 μm on the inner and outer walls of the pipe, the process for producing surface copper-iron alloy pipes by arc spraying electric heating is as follows:

S21: Install the raw metal wire to the wire feeder and adjust the wire feeding voltage to 30V, adjust the spraying current (100-400 A) to 100 A.

S22: Spraying the inner hole of pipe: fix the pipe to the chuck and adjust the chuck speed (0-200 rpm) to 100 rpm, place the inner wall spray gun into the pipe inner hole, the inner wall spray gun travels to the other end of the pipe, turn on the equipment, and the spraying trolley moves backward at a constant speed (0-0.3 m/s), the inner wall spraying of the pipe is completed. Spraying the outer hole of pipe: after adjusting the chuck speed, move the pipe to the position of the outer spraying port, adjust the moving speed of the chuck (0-0.3 m/s) to the appropriate speed, turn on the equipment, the outer wall spraying of the pipe is completed.

S23: After the pipe is sprayed, naturally cool it to room temperature;

S24: Put the cooled pipe into the heating furnace, turn on the heating, start insulation for 45 minutes when the temperature of the pipe rises to 910° C. Pull out the pipe for natural cooling outside the furnace after the end of the insulation. At this time, the surface copper-iron alloy layer is formed on the inner and outer wall of the carbon steel pipe.

S25: After the pipes are cooled down to room temperature, the pipes are heat-treated using intermediate-frequency heat-treatment equipment according to the heat-treatment process for steel-grade N80-1 pipes.

The said raw metal wire is copper wire with a copper element content of 99% or more.

After the Step S21 of the present invention, a copper coating of 150 μm will be formed on the inner and outer walls of the pipe, and after all the process steps have been completed, the resulting surface copper-iron alloy pipe includes pipe body 2.1, surface alloy layer 2.2 on the pipe inner wall and surface alloy layer 2.3 on the pipe outer wall. The thicknesses of surface alloy layer 2.2 on the pipe inner wall and surface alloy layer on the pipe outer wall can be up to 200 μm, with hardness up to 350HV_{0.1}.

### Example 3

For the production of surface copper-aluminium-iron alloy layer pipe of 3-½-inch, steel grade J55, with a surface alloy layer thickness of 400 μm on the inner and outer walls of the pipe, the process for producing surface copper-aluminium-iron alloy pipes by arc spraying electric heating is as follows: S31: Install the raw metal wire to the wire feeder and adjust the wire feeding voltage to 30V, adjust the spraying current (100-400 A) to 100 A.

S32: Spraying the inner hole of pipe: fix the pipe to the chuck and adjust the chuck speed (0-200 rpm) to 100 rpm, place the inner wall spray gun into the pipe inner hole, the inner wall spray gun travels to the other end of the pipe, turn on the equipment, and the spraying trolley moves backward at a constant speed (0-0.3 m/s), the inner wall spraying of the pipe is completed. Spraying the outer hole of pipe: after adjusting the chuck speed, move the pipe to the position of the outer spraying port, adjust the moving speed of the chuck (0-0.3 m/s) to the appropriate speed, turn on the equipment, the outer wall spraying of the pipe is completed.

S33: After the pipe is sprayed, naturally cool it to room temperature;

S34: Put the cooled pipe into the heating furnace, turn on the heating, start insulation for 60 minutes when the temperature of the pipe rises to 880° C. Pull out the pipe for natural cooling outside the furnace after the end of the insulation. At this time, the surface copper-aluminium-iron alloy layer is formed on the inner and outer wall of the carbon steel pipe.

S35: After the pipes are cooled down to room temperature, the pipes are heat-treated using intermediate-frequency heat-treatment equipment according to the heat-treatment process for steel-grade J55 pipes.

The said raw metal wire is copper-aluminium mixed wire with a common content of the elements aluminium and aluminium of 99% or more.

After the Step S31 of the present invention, a copper-aluminium coating of 200 μm will be formed on the inner and outer walls of the pipe, and after all the process steps have been completed, the resulting surface copper-aluminium-iron alloy pipe includes pipe body 2.1, surface alloy layer 2.2 on the pipe inner wall and surface alloy layer 2.3 on the pipe outer wall. The thicknesses of surface alloy layer 2.2 on the pipe inner wall and surface alloy layer 2.3 on the pipe outer wall can be up to 400 μm, with hardness up to 370HV_{0.1}.

The present invention solves the problems that the existing arc spraying device can not spray the inner wall of the pipe and the spraying layer is easy to fall off because of the poor combination of the spraying layer and the pipe body, and greatly improves the wear-resistant, high temperature-resistant and corrosion-resistant properties of the inner and outer surfaces of the pipe, and increases the service life of the pipe. When arc spraying the inner (and/or) outer wall of carbon steel pipe, because the surface alloy layer has great requirements for the uniformity of arc spraying, the use of ordinary arc spraying equipment not only fails to spray the pipe inner wall, but also fails to ensure the uniformity of the spraying of the pipe outer wall. The use of spraying equipment of the present invention solves these problems. Defects of ordinary arc spraying equipment in spraying the inner (and/or) outer walls of pipes:
1. The spray gun of ordinary arc spraying equipment is a hand-held spray gun, which causes a large difference in spraying thickness on the radial direction of the pipe when spraying the pipe outer wall, which results in an uneven alloy layer thickness on the surface of the pipe formed in the end.
2. Ordinary arc spraying equipment does not have a spray gun capable of spraying the pipe inner wall, and cannot spray the pipe inner wall.

The present invention has the following beneficial effects:
(1) The inner wall (and/or) outer wall of the carbon steel pipe has formed a uniform surface alloy layer with a thickness of 30-600 μm, which is mainly made of aluminium-iron alloy, and its hardness can reach 400-600HV_{0.1}, which is much higher than that of the ordinary carbon steel pipe, and greatly improves the abrasion resistance of the pipe. The corrosion resistance of surface alloy layer to H2S, CO2, Cl— and other corrosion resistance is several times that of ordinary carbon steel pipes, and because of the dense oxide film on the surface of the alloy layer, the surface alloy pipe will not appear hydrogen-induced stress corrosion cracking phenomenon.
(2) The surface alloy layer is metallurgically bonded to the carbon steel pipe substrate, which has a better bonding strength than other processes such as plating, coating of anti-corrosion material layer or sintered glass lining, etc., and coupled with the improved surface hardness of the alloy layer, the surface alloy layer will not fall off even if there is a serious irregular-wear phenomenon.
(3) The surface alloy layer also has excellent high-temperature resistance, and will not change under 800° C., making it ideal for use in high-temperature working environments, and its corrosion resistance is even better at high temperatures than at low temperatures.

1. A process of arc spraying carbon steel pipes, including the following steps:
S1: installing a raw metal wire on a wire feeder, adjusting a voltage of the wire feeding according to a required thickness of spraying, and adjusting a spraying current according to a material of the raw metal wire;
S2: spraying an inner wall and an outer wall of a pipe through an inner wall spray gun and an outer wall spray gun;
S3: after the pipe is sprayed, cooling the pipe naturally to room temperature;
S4: putting the cooled pipe into a heating furnace, adjusting a heating temperature according to a required surface alloy thickness, and cooling the pipe in the furnace or natural cooling outside the furnace after an insulation is completed; a surface alloy layer being formed on the inner and/or outer wall of the carbon steel pipe;
S5: after the pipe is cooled to room temperature, using a medium frequency heat treatment equipment to treat the pipe through a heat treatment process.

2. The process of arc spraying carbon steel pipes according to claim 1, wherein before step S1, the inner and outer walls of the carbon steel pipe are shot blasted and rust removed respectively to make the inner and outer walls of the pipe appear metallic.

3. The process of arc spraying carbon steel pipes according to claim 1, wherein in step S2, the inner wall and outer wall of the pipe are sprayed by the inner wall spray gun and the outer wall spray gun according to the following steps first, the inner wall spray gun does not move, and the pipe is fixed to a rotating chuck, wherein the rotating chuck drives the pipe to move by moving a slide rail so that the inner wall spray gun and the outer wall spray gun are sprayed at the same time; and second, the pipe does not move, the pipe is fixed to the rotating chuck, the wire feeder and the inner wall spray gun are fed into the inner wall of the pipe, and are ceased after traveling to the other end of the pipe, and then the wire feeder and inner wall spray gun are moved back while spraying the inner wall.

4. The process of arc spraying carbon steel pipes according to claim 3, wherein when the carbon steel pipe is sprayed, the moving speed of the inner wall spray gun and/or the outer wall spray gun relative to the pipe is 0-0.3 meters/second.

5. The process of arc spraying carbon steel pipes according to claim 1, wherein in step S4, the surface alloy layer is an alloy layer mainly composed of aluminum-iron alloy, copper-iron alloy or copper-aluminum-iron alloy, which accounts for more than 80% of the entire surface alloy layer; wherein the thickness of the surface alloy layer is 30-600 μm, and its hardness is 300-600 HV_{0.1}.

6. The process of arc spraying carbon steel pipes according to claim 1, wherein in step S4, said heating furnace is a resistance heating furnace, a direct current heating furnace or an intermediate frequency furnace; the heating temperature range is in the range of 800-1200° C., and the holding time is 10-300 minutes.

7. A spraying device for arc spraying carbon steel pipe, including a control cabinet, a wire feeder, raw metal wires, an inner wall spray gun, an outer wall spray gun, a rotating chuck and a moving slide rail, wherein: the control cabinet is used for controlling of spraying device, a lower end of the rotating chuck is installed on the moving slide rail to fix a pipe and drive the pipe to rotate; the inner wall spray gun and the outer wall spray gun are used to spray inner and outer walls of the pipe; the raw metal wires are sent to an end of the inner wall spray gun through the wire feeder, the raw metal wires at the end form the molten metal when energized, and the molten metal is blown by air to a surface of the inner wall of the pipes.

8. The spraying device for arc spraying carbon steel pipe according to claim 7, wherein: the end of the inner wall spray gun includes a spray gun shell, a main air path, an auxiliary air path, an air cap, a copper row, a conductive nozzle, a conductive tube and a conductive rod; an upper edge of an opening of the spray gun shell exceeds a lower edge thereof, an internal space is provided with the main air path and the air cap from top to bottom, an air path outlet of the main air path exceeds the air cap and sprays downward; the air cap is connected to the auxiliary air path and the conductive nozzle, and the conductive nozzle is connected to the copper row, conductive rod, and conductive tube in sequence; the copper row is used to conduct electricity and introduce electricity from a power supply to the conductive nozzle.

9. The spraying device for arc spraying carbon steel pipe according to claim 7, wherein: said air cap includes an air blowing port, a positive electrode, a negative electrode and an air gathering port, said air blowing port is located above the air gathering port, left and right sides of said air gathering port are respectively a positive electrode and a negative electrode, said positive electrode is a raw metal wire connected to a positive pole of a power supply, and the negative electrode is a raw metal wire connected to a negative electrode of the power supply, and said positive electrode and negative electrode are connected to a conductive nozzle.

10. The spraying device for arc spraying carbon steel pipes according to claim 9, wherein the air source of said air blowing port is provided by an auxiliary air path, and the air gathering port collects the air blown out of the air blowing port and blows it out from the air gathering port, the main air path and the auxiliary air path are distributed in different directions and positions, and the main air path blows the molten metal sprayed from the air gathering port to the inner wall of the pipe, forming a spray angle of 60°-90° with the pipe wall to ensure the adhesion and homogeneity of the spraying.

11. The spraying device for arc spraying carbon steel pipes according to claim 8, wherein: a connecting pipe of the inner wall spray gun includes a gas duct, a metal wire duct and positive and negative cables, and the gas duct is in the middle of the connecting pipe, left and right sides outwardly are sequentially provided with a positive and negative cable and a metal wire duct, said wire feeder pushes the raw metal wires into the metal wire duct, which is pushed all way through the metal wire duct to an end position of the inner wall spray gun, said gas duct is connected to a main gas circuit and an auxiliary gas circuit, said metal wire duct is connected to the conductive tube, and said positive and negative cables are connected to the conductive nozzles through copper rows, so that two said raw metal wires are formed into a positive electrode and a negative electrode, respectively.

12. The spraying device for arc spraying carbon steel pipes according to claim 7, wherein an outer diameter of the inner wall spray gun is 40-150 mm, and its length is 2.5-15 m.

13. The spraying device for arc spraying carbon steel pipes according to claim 7, wherein: the rotating chuck includes a motor, a chuck, rotating rollers, a driving transmission shaft, a bearing, and a cylinder, and the chuck is fixed on the transmission shaft, the transmission shaft is fixed by two bearings, the motor drives the transmission shaft to rotate the chuck, the rotating rollers are two rollers fixed on a steel plate, a lower side is connected to the cylinder, which can be lifted by the cylinder to avoid collision of the chuck and effectively support the pipe body.

14. The spraying device for arc spraying carbon steel pipes according to claim 7, wherein the metal raw material wire is an aluminum wire with an aluminum content of more than 99%, or a copper wire with a copper content of more than 99%, or copper-aluminum mixed wire with a common content of more than 99% of copper and aluminum elements.
